(19) United States
(12) Patent Application Publication
(10) Pub. No.: US 2025/0305878 A1
(43) Pub. Date: Oct. 2, 2025

(54) PROGRAMMABLE SCANNING DIFFUSE SPECKLE CONTRAST IMAGING (PS-DSCI) OF DEEP TISSUE OPTICAL PROPERTIES, HEMODYNAMICS, AND FUNCTION

(71) Applicant: University of Kentucky Research Foundation, Lexington, KY (US)

(72) Inventors: Guoqiang Yu, Lexington, KY (US); Faezeh AKBARI, Lexington, KY (US); Xuhui LIU, Davis, CA (US); Fatemeh HAMEDI, Lexington, KY (US); Mehrana MOHTASEBI, Philadelphia, PA (US); Faraneh Fathi, Lexington, KY (US); Chaebeom YEO, Lexington, KY (US); Lei Chen, Lexington, KY (US)

(21) Appl. No.: 18/985,503

(22) Filed: Dec. 18, 2024

Related U.S. Application Data
(60) Provisional application No. 63/570,907, filed on Mar. 28, 2024.

(51) Int. Cl. G01J 3/28; G01J 3/02; G01J 3/06

(52) U.S. Cl. CPC G01J 3/2823; G01J 3/0229; G01J 3/0237; G01J 3/0256; G01J 3/06; G01J 3/2803; G01J 3/0208; G01J 3/021; G01J 3/0224; G01J 2003/2826

(57) ABSTRACT

A portable and cost-effective programmable scanning diffuse speckle contrast imaging (PS-DSCI) technique enables noncontact, fast and high-density imaging of deep tissue blood flow, blood oxygenation, and tissue optical properties. PS-DSCI incorporates a digital micromirror device (DMD) for programmable fast scanning of near-infrared lights (e.g., line shape scanning) at different wavelengths over a large region of interest (ROI). A high-resolution 2D camera captures intensity images at each scanning source position. Novel image processing algorithms are created to define the pixel/detection areas at varied distances from the illumination center for capturing diffused photons from the tissue at varied depths. Spatial laser speckle contrasts are calculated in the defined detector regions and then converted to blood flow images at different depths. Line-shape scanning enables high temporal resolution to detect low-frequency oscillations (<0.1 Hz) across different brain regions, thus allowing for the reconstruction of brain functional connectivity maps.

### CROSS REFERENCE TO RELATED APPLICATIONS

This application claims the benefit of U.S. provisional patent application No. 63/570,907, filed Mar. 28, 2024, the contents of which are herein incorporated by reference.

### BACKGROUND OF THE INVENTION

### 1. Field of the Invention

Embodiments of the invention relate generally to apparatus and methods for determining deep tissue optical properties, hemodynamics and function. More particularly, embodiments of the invention relate to a programmable scanning diffuse speckle contrast imaging (PS-DSCI) apparatus and method of using the apparatus to determine deep tissue optical properties, hemodynamics and function in a subject.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Continuous measurements of tissue blood flow and oxygenation are essential for understanding neurovascular pathologies and guiding medical interventions. Optical modalities for imaging of tissue blood flow and oxygenation emerge as valuable tools owing to their cost-effectiveness, portability, rapidity, and suitability for continuous and longitudinal measurements at the bedside. However, existing optical modalities face limitations in achieving high spatiotemporal resolution, large region-of-interest (ROI), and deep penetration depth.

Blood flow plays a critical role in sustaining tissue health and function. Blood flow serves as the conduit for delivering essential oxygen and nutrients while facilitating the removal of waste products. Additionally, tissue blood flow contributes to thermal regulation, ensuring optimal temperature conditions. The vitality and functionality of tissue are intricately linked to the efficiency of blood circulation and hemodynamic processes. Imaging tissue blood flow and oxygenation distributions holds immense potential for the diagnosis and therapeutic management of numerous vascular and cellular diseases.

Various modalities exist for monitoring tissue blood flow and oxygenation. Non-optical methods, such as functional magnetic resonance imaging (fMRI) and positron emission tomography (PET), offer the capability of whole-body imaging of tissue hemodynamics and metabolism. However, the high cost and poor mobility make them unsuitable for bedside continuous monitoring. Optical imaging modalities present a compelling alternative due to their portability, affordability and high temporal resolution. Laser speckle contrast imaging (LSCI), for example, boasts high spatiotemporal resolution but is limited in penetration depth (less than 1 mm) due to its use of wide field illumination. Laser Doppler flowmetry (LDF), diffuse speckle contrast flowmetry (DSCF), diffuse correlation spectroscopy (DCS) and diffuse optical tomography (DOT) are mostly contact measurement devices that utilize limited numbers of discrete sources and detectors for tissue hemodynamic measurements with poor spatial resolutions.

An innovative noncontact speckle contrast diffuse correlation tomography (scDCT) system was recently developed for high-density imaging of tissue hemodynamic distributions. In the scDCT, a galvo mirror remotely delivers coherent point near-infrared light to many source positions on a selected ROI for deep tissue penetration. A high-resolution sCMOS camera measures diffuse spatial speckle contrast (Ks) on the tissue boundary, resulting from the movement of red blood cells (i.e., blood flow) in the measured tissue volume. Continuous and longitudinal imaging of cerebral blood flow (CBF) distributions in a 3D manner has been demonstrated with scDCT in head-simulating phantoms and in vivo cerebral tissues of rodents, piglets and human infants. While effective, scDCT requires scanning of point light to numerous source positions for high-density sampling, which is very time consuming. Thus, a functional connectivity (FC) map that requires capturing low-frequency oscillations (LFOs: <0.1 Hz) across different brain regions is not yet accessible due to the low temporal resolution of scDCT.

As can be seen, there is a need for systems and methods for a portable and cost-effective programmable imaging technique which enables noncontact, fast and high-density imaging of deep tissue blood flow, blood oxygenation and tissue optical properties.

### SUMMARY OF THE INVENTION

Embodiments of the present invention relate to an affordable, portable, noncontact optical imaging device, known as programmable scanning diffuse speckle contrast imaging (PS-DSCI), to quantify deep tissue blood flow and oxygenation, tissue optical properties and tissue surface geometry. This innovative PS-DSCI employs programable scanning illumination (e.g., line shape scanning) on the tissue surface by a digital micromirror device (DMD) and a fast-sampling camera to capture diffused photons from deep tissues, thus uniquely balancing the spatial and temporal resolutions with depth sensitivity. The utilization of line scanning by the fast and programable DMD instead of traditional point scanning enables remarkable improvements in temporal resolution. Depth sensitive images of tissue blood flow are reconstructed from boundary spatial speckle contrasts defined at varied distances from the illumination center. PS-DSCI imaging depths are approximately one half of the source-detector distances.

Embodiments of the present invention provide a system for determining deep tissue optical properties, hemodynamics and function comprising a laser operable to illuminate homogeneous widefield light; a programable DMD configured to receive light from the laser and operable to generate a line shape beam directed at a ROI of a subject; and a camera synchronized with the DMD to continuously capture raw intensity images from the ROI.

In some embodiments, which may be combined with the above embodiment, the laser is an open-space coherent laser.

In some embodiments, which may be combined with the above embodiment, the laser is a fiber coupled coherent laser.

In some embodiments, which may be combined with any of the above embodiments, the system further comprises a collimating lens receiving light from the laser.

In some embodiments, which may be combined with any of the above embodiments, the system further comprises a beam shaper to create a rectangular/square shape illumination matching the DMD area.

In some embodiments, which may be combined with any of the above embodiments, the system further comprises a mirror for reflecting light from the collimating lens toward a micromirror window of the DMD.

In some embodiments, which may be combined with any of the above embodiments, the system further comprises a projection lens to image out the entire DMD with higher resolution.

In some embodiments, which may be combined with any of the above embodiments, the system further comprises a zoom lens on the camera.

In some embodiments, which may be combined with any of the above embodiments, the system further comprises a set of linear polarizers (one on the illumination path and the other on the imaging path) and a long-pass filter in front of the zoom lens.

In some embodiments, which may be combined with any of the above embodiments, the camera is a scientific complementary metal-oxide semiconductor (sCMOS) camera.

In some embodiments, which may be combined with any of the above embodiments, the camera is an InGaAs camera (SWIR camera).

In some embodiments, which may be combined with any of the above embodiments, the DMD generates structured scanning patterns at different phases and/or frequencies.

In some embodiments, which may be combined with any of the above embodiments, the DMD is used to generate different scanning patterns such as cross shape scanning, parallel line scanning, single point scanning, and multipoint scanning.

In some embodiments, which may be combined with any of the above embodiments, the DMD is used to generate a sequential scanning pattern.

In some embodiments, which may be combined with any of the above embodiments, the DMD is used to generate a multiple coverage interleaved scanning sequence to enhance the temporal resolution.

Embodiments of the present invention further provide a method of determining deep tissue optical properties, hemodynamics and function comprising a programable DMD receiving homogeneous light from a laser; directing the programmed scanning beam, generated from the DMD, at an ROI of a subject; and continuously capturing raw intensity images from the ROI with a camera synchronized with the DMD.

Embodiments of the present invention further provide an integrated instrument for performing measurements, comprising a coherent laser operable to illuminate coherent near-infrared light; a DMD configured to receive light from the laser and operable to generate a line shape beam directed at a ROI of a subject; and a sCMOS camera synchronized with the DMD to continuously capture raw intensity images from the ROI, wherein the integrated instrument is portable and movable.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates point-scanning scDCT versus PS-DSCI, where, in contrast to 625 scanning points by the scDCT, PS-DSCI covers the same ROI with only 50 scanning lines;

FIG. 2A illustrates a PS-DSCI system according to an exemplary embodiment of the present invention;

FIG. 2B illustrates how the programmable DMD generates different scanning patterns;

FIG. 2C illustrates structured line scanning patterns at different spatial frequencies;

FIG. 2D illustrates a PS-DSCI system according to an exemplary embodiment of the present invention;

FIG. 2E illustrates a PS-DSCI system using a fiber coupled coherent laser, according to an exemplary embodiment of the present invention;

FIG. 3 illustrates a one-dimensional plot of the multiple coverage interleaved scanning sequence (MCIS), where long vertical dashed lines indicate groups of 100 scanning lines used for generating high-resolution 2D BFI maps, and short dashed lines represent groups of 10 scanning lines used for generating low-resolution 2D BFI maps, designed for fast time-course analysis;

FIG. 4A illustrates a raw intensity image of vertical oval-shape sources;

FIG. 4B illustrates binary masks of vertical oval-shape sources;

FIG. 4C illustrates the elliptical-shape detector belts with varied S-D separations of 1 to 3 mm and varied detector belt thicknesses of 1 to 3 mm;

FIG. 4D illustrates a raw intensity image of horizontal oval-shape sources;

FIG. 4E illustrates binary masks of horizontal oval-shape sources;

FIG. 4F illustrates the elliptical-shape detector belts with varied S-D separations of 1 to 3 mm and varied detector belt thicknesses of 1 to 3 mm;

FIG. 5 illustrates structured line scanning light patterns for depth sensitive SFDI;

FIG. 6A illustrates reconstructed flow images showing 1 mm top-layer phantom test results;

FIG. 6B illustrates reconstructed flow images showing 2 mm top-layer phantom test results;

FIGS. 6C and 6D illustrate reconstructed flow images showing baseline CBF maps in wild-type mice;

FIG. 7A illustrates baseline time course results of a wild-type mouse with conventional sequential scanning;

FIG. 7B illustrates baseline time course results of a wild-type mouse with MCIS;

FIG. 8A illustrates in vivo test results in mice (n=7) showing resting-state reconstructed CBF maps of a representative mouse;

FIG. 8B illustrates corresponding resting-state FC maps at different brain regions including muscle, motor, somatosensory, limbic, and visual areas;

FIGS. 9A and 9B illustrate a 3D visualization of blood flow on top of tissue surface geometry, showing CBF data captured from a mouse head by the PS-DSCI;

FIGS. 9C and 9D illustrate a 3D visualization of blood flow on top of tissue surface geometry, showing blood flow maps captured from a hand palm by the scDCT.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Unless otherwise indicated, all numbers expressing quantities of ingredients, properties such as reaction conditions, and so forth used in the specification and claims are to be understood as being modified in all instances by the term “about”. Accordingly, unless indicated to the contrary, any numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, in some embodiments ±0.1%, in some embodiments ±0.01%, and in some embodiments ±0.001% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, “optional” or “optionally” means that the subsequently described event or circumstance does or does not occur and that the description includes instances where said event or circumstance occurs and instances where it does not. For example, an optionally variant portion means that the portion is variant or non-variant.

As used herein, the term “subject” refers to a target of administration or medical procedure. The subject of the herein disclosed methods can be a human or animal. The subject may also be a mammal. Thus, the subject of the herein disclosed methods can be a human, nonhuman primate, horse, pig, rabbit, dog, sheep, goat, cow, cat, guinea pig or rodent. The term does not denote a particular age or sex. Thus, adult and newborn subjects, as well as fetuses, whether male or female, are intended to be covered. A “patient” refers to a subject afflicted with a disease or disorder. The term “patient” includes human and veterinary subjects.

As used herein, the term “diagnosed” means having been subjected to a physical examination by a person of skill, for example, a physician, and found to have a condition that can be diagnosed or treated by the compounds, compositions, or methods disclosed herein. For example, “diagnosed with hypoxic-ischemic encephalopathy” means having been subjected to a physical examination by a person of skill, for example, a physician, and found to have a condition that can be described as hypoxic-ischemic encephalopathy.

Broadly, embodiments of the present invention provide an innovative, safe, movable, portable, and cost-effective programmable scanning diffuse speckle contrast imaging (PS-DSCI) technique, which enables noncontact, fast, and high-density continuous and longitudinal imaging of deep tissue blood flow, blood oxygenation and tissue optical properties. PS-DSCI incorporates a digital micromirror device (DMD) for programmable fast scanning of near-infrared light (e.g., line shape scanning) over a flexible ROI. A high-resolution 2D camera captures intensity images at each scanning source position. Novel image processing algorithms are created to define the pixel/detection areas at varied distances from the illumination center for capturing diffused photons from the tissue at different depths. Spatial laser speckle contrasts are calculated in the defined detector regions and then converted to blood flow images at different depths. Line-shape scanning enables high temporal resolution to detect low-frequency oscillations (<0.1 Hz) across different brain regions, thus allowing for the reconstruction of brain functional connectivity (FC) maps. The temporal resolution of time-course variations can be further enhanced using the multiple coverage interleaved scanning (MCIS) approach compared to conventional sequential scanning. Additionally, tissue surface geometry is innovatively reconstructed by using the same boundary intensity data captured by the PS-DSCI.

The reconstructed tissue blood flow and surface geometry are integrated to enhance data analysis and visualization, and can be used to reconstruct geometry corrected images. By integrating multiple-wavelength illuminations in the near-infrared range (600 to 1100 nm), tissue oxygenation images at varying depths are quantified based on near-infrared spectroscopy principles. Moreover, DMD enables the generation of structured scanning patterns at different phases and frequencies, facilitating the reconstruction of tissue optical properties (absorption and scattering coefficients) at different depths based on spatial-frequency-domain-imaging principles. The efficient programable scanning approach, with effective image processing algorithms, supports nearly real-time reconstruction of tissue optical properties, tissue hemodynamics, and tissue surface geometry. The performance of PS-DSCI has been evaluated on both tissue-simulating phantoms and rodents with intact skulls. Overall, the innovative PS-DSCI approach holds the potential for use in both animals and humans as a promising alternative to other functional imaging modalities.

Aspects of the present invention provide an affordable, portable, noncontact optical imaging device, referred to herein as programmable scanning diffuse speckle contrast imaging (PS-DSCI), to quantify deep tissue blood flow and oxygenation, tissue optical properties and tissue surface geometry. PS-DSCI employs programable scanning illumination (e.g., line shape scanning) on the tissue surface by a DMD and a fast-sampling camera to capture diffused photons from deep tissues, thus uniquely balancing the spatial and temporal resolutions with depth sensitivity. The utilization of line scanning by the fast and programable DMD, instead of traditional point scanning, enables remarkable improvements in spatiotemporal resolution. Depth sensitive images of tissue blood flow are reconstructed from boundary spatial speckle contrasts defined at varied distances from the illumination center. PS-DSCI imaging depths are approximately one half of the source-detector distances.

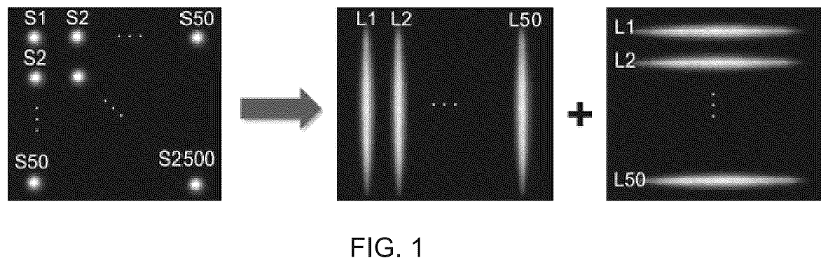

FIG. 1 illustrates a comparison between the point scanning method (scDCT) with 2500 scanning points and the line scanning approach (PS-DSCI) with 100 scanning lines over a selected ROI. With the line scanning in PS-DSCI, the sampling rate increases by a factor of

$$\frac{{n}^{2}}{2 n} = \frac{n}{2} ,$$

where n is the number or scanning points (in vertical or horizontal direction). For example, for n=50, using the same camera for both setups (C11440-42U40, Hamamatsu), with the frame rate of 24 fps, the sampling rate increases from 0.0096 Hz (total 50×50 scanning points in scDCT) to 0.24 Hz (total 50+50 scanning lines in PS-DSCI), respectively, representing a 25-fold enhancement achieved by the PS-DSCI. In contrast to point-scanning, the innovative line-scanning significantly diminishes the number of raw intensity images required for flow reconstruction, resulting in reduced computation time and storage. Table 1, below, outlines the distinctions between point-scanning scDCT and line scanning PS-DSCI.

The sampling rate of PS-DSCI can be further increased with a scanning approach, called multiple coverage interleaved scanning (MCIS). MCIS involves acquiring lines in an alternating (non-sequential) order rather than consecutively. This method provides low-density coverage of the ROI multiple times in each scanning round. By aggregating several rounds of recursive, low-density scans (e.g., 10 lines per round), MCIS achieves a full-density scan (e.g., 100 lines) for high-resolution 2D flow map reconstruction, while enhancing temporal resolution and reducing motion artifacts. The enhanced sampling rate allows capturing heart rate and breathing rate as well as LFOs.

The high sampling rate of PS-DSCI allows for capturing LFOs and consequently extracting FC maps. The FC map refers to the temporal correlations between spatially distributed neurophysiological events. The extraction of FC maps provides valuable insights into disease pathologies, neurovascular coupling, functional reorganization, and potential targets for neurorehabilitation.

The same intensity images collected by the PS-DSCI can be used to reconstruct tissue surface geometry. Integrating geometric and blood flow images facilitate easy observation of blood vessels and allows for precise co-registration of structural and functional information and reconstructing geometry corrected images.

Through incorporation of multiple-wavelength spectral illuminations, PS-DSCI enables spectral imaging of oxyhemoglobin concentration [HbO₂], deoxyhemoglobin concentration [Hb], and blood oxygen saturation (StO₂=[HbO₂]/([HbO₂]+[Hb]) using near-infrared spectroscopy principles.

Taking advantage of the flexibility of the DMD in generating different illumination patterns, structured illuminations can be created with the spatial-frequency-domain-imaging (SFDI) technique for the quantification of tissue optical properties including tissue absorption coefficient (μₐ) and reduced scattering coefficient (μ′ₛ). Knowledge of μₐ and μ′ₛ also improves the accuracy of blood flow measurements since PS-DSCI measurements are dependent of μₐ, μ′ₛ, and tissue blood flow.

Simultaneous imaging of multiple functional parameters (μₐ, μ′ₛ, tissue blood flow, [HbO₂], [Hb], StO₂, and FC) provides a comprehensive understanding of complex interactions between oxygen supply, oxygen utilization and neurovascular responses. Abnormal tissue blood flow and oxygenation levels can also be early indicators of various physiological and pathological conditions.

TABLE 1
Comparisons between the point scanning and line scanning

| | Number of | Sampling | Computation | Storage |
|---|---|---|---|---|
| Methods | Images | Rate (Hz) | Time (s) | (Megabytes) |
| Point scanning | 2500 (50 × | 0.0096 | ~410 | 20000 |
| | 50 points) | | | |
| Line scanning | 100 (50 + | 0.24 | ~17 | 800 |
| | 50 lines) | | | |

### Methods

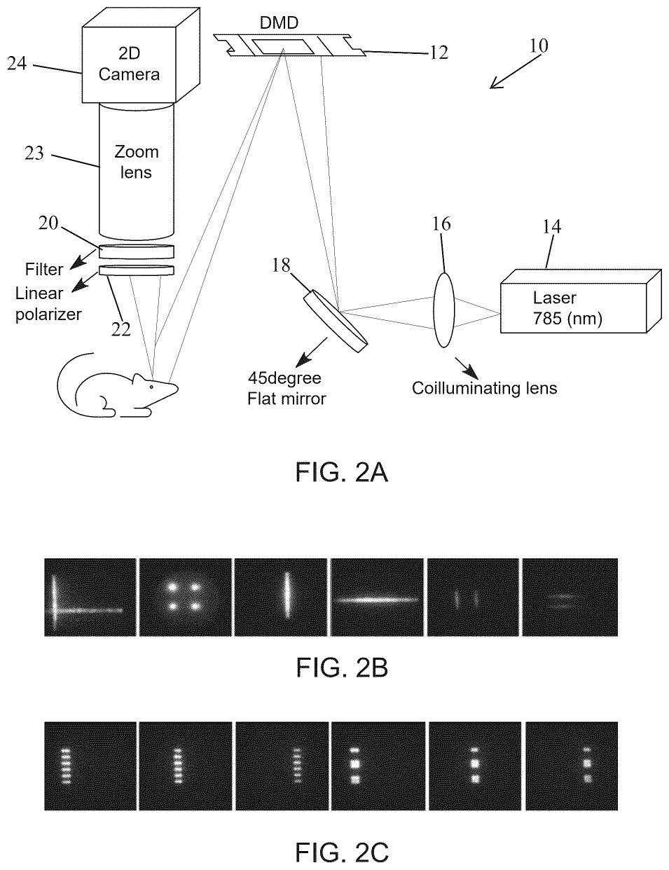

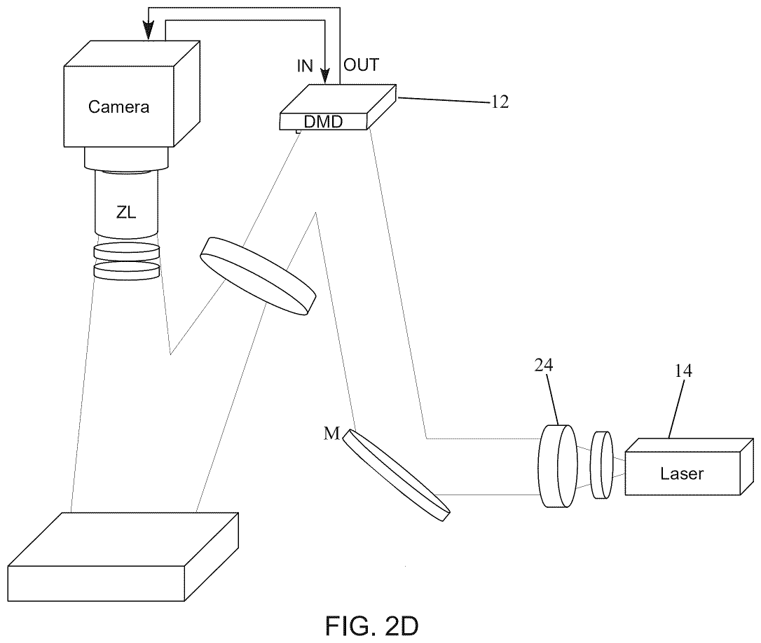

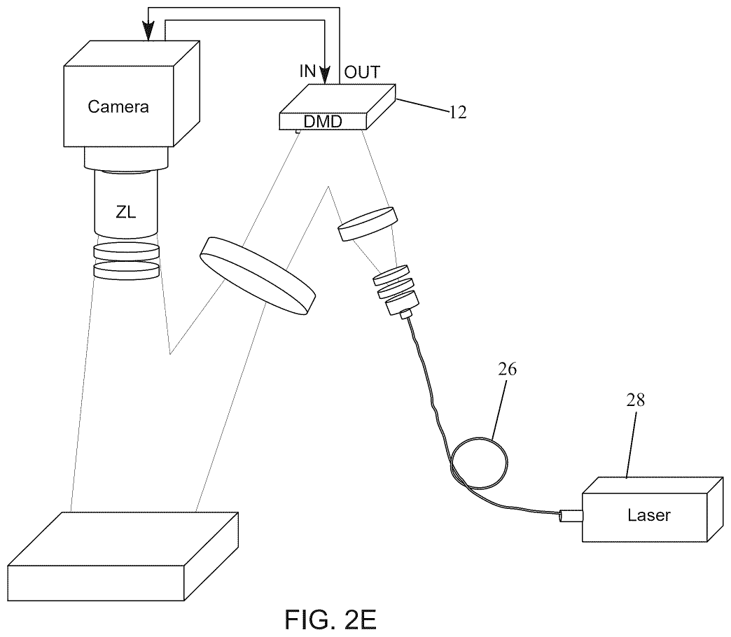

PS-DSCI Instrumentation. A programable DMD 12 (DLP4500, Texas Instruments) was employed to generate fast line scanning in the PS-DSCI system 10, as illustrated in FIG. 2A. The DMD 12 serves as a pivotal component, enabling precise and programmable control over a designed illumination pattern. The use of the DMD 12 introduces flexibility and adaptability to the scanning process, contributing to the effectiveness and versatility of the PS-DSCI system 10. An open-space polarized coherent laser 14 (785 nm, CrystaLaser) illuminates homogenous widefield light (via a collimating lens 16 and a 45° flat mirror 18) on the micromirror window of the DMD 12. The programable DMD 12 generated a scanning line shape beam that scanned over the ROI. Alternatively, a projection lens can be used to image out the scanning line shape beam on the ROI A sCMOS camera 24 (C11440-42U40, Hamamatsu) was synchronized with the DMD 12 to continuously capture raw intensity images on the ROI via a zoom lens 22. A linear polarizer 20 and a long-pass filter 22 were installed in front of the zoom lens 23 to reduce specular reflection and ambient light, respectively. These components were installed on a vertical optical table to facilitate animal experiments. This compact setup allows for assembling the PS-DSCI system 10 on a portable, movable cart to facilitate bedside measurements.

In some embodiments, as shown in FIG. 2D, a beam shaper 24 can be used to create a rectangular/square shape illumination, matching or substantially matching the DMD area.

In some embodiments, as shown in FIG. 2E, the laser can be a fiber coupled coherent laser 26, delivering a beam to the DMD 12 via a fiber 28.

In addition, line-shape scanning can be generated using alternative methods, including a line laser, a point laser integrated with a cylindrical lens and a 2D axis galvo mirror, 2D axis micro-electro-mechanical systems (MEMS) or spatial light modulators (SLM). However, the programable DMD extends beyond horizontal and vertical line scanning and allows for the generation of various rapid scanning patterns, including cross-shaped scanning, parallel lines, and multipoint scanning (see FIG. 2B). This inherent flexibility empowers us to optimize scanning patterns that yield maximum spatiotemporal resolution.

The DMD in the PS-DSCI can generate structured scanning patterns at different phases/frequencies as shown in FIG. 2C. By integrating the source-detector separation approach, optical properties (μa and μ′s) can be imaged at different depths using the spatial frequency domain imaging (SFDI) principle.

The current PS-DSCI setup allows for multiple spectral measurements by adding more light sources at different wavelengths. This capability also allows the use a light source with a longer wavelength (1064 nm), which has been proven to generate higher signal to noise ratio (SNR) at larger source detector separations. Through the utilization of two or more distinct wavelengths in the near-infrared range (e.g., 690, 800, 830 nm), quantification of [HbO₂] and [Hb] is achievable.

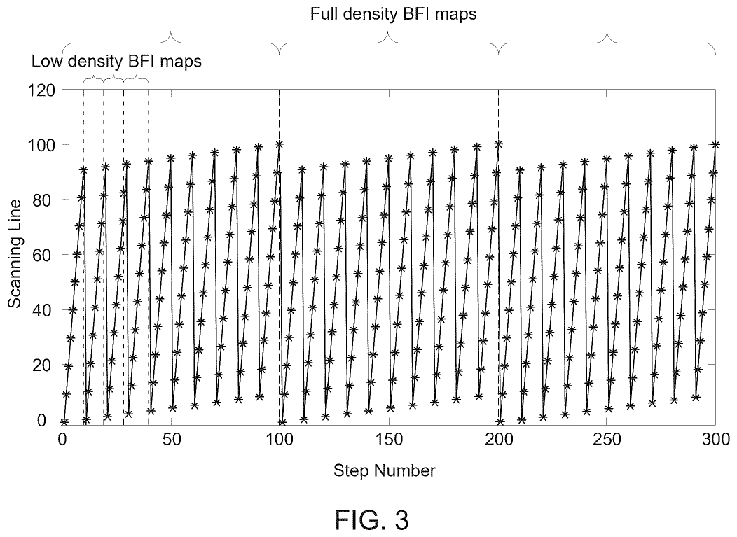

MCIS Approach. The MCIS approach achieves full-density coverage through multiple rounds of low-density scanning across the ROI. Each low-density scan covers the entire ROI using a subset of lines that shifts by one position to the right in each subsequent round. This recursive process continues until all defined lines (e.g., 100 lines) complete a full-density scan. The full-density scan is then used to reconstruct high-resolution blood flow index (BFI) maps, while low-density scanning rounds enable low-resolution BFI maps for tracking temporal changes. The interleaved scanning approach significantly improves temporal resolution for time-course analysis without sacrificing spatial resolution. FIG. 3 shows the sequence of scanning in the interleaved scanning approach for 100 lines.

### Reconstruction Algorithms

Tissue Blood Flow Reconstruction. The innovative approach for depth-sensitive flow reconstruction, according to embodiments of the present invention, involves defining a detection area located at certain distances from the scanning source, with the goal of selectively capturing diffused photons originating from certain depths. This method effectively eliminates single-scattering photons emanating from the tissue surface. The imaging depth depends on the selected source-detector separation. The diffused laser speckle contrasts are calculated over the defined detection areas. These boundary data are then reconstructed to generate 2D maps of tissue blood flow.

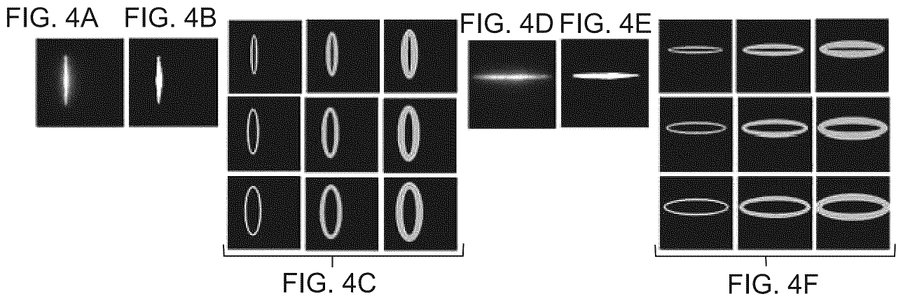

The synchronization of the DMD and sCMOS camera ensures capture of one intensity image at each scanning source position. Due to the tissue curvature and Gaussian distribution of the light source, the initial line shape of light transforms into an oval shape. The initial step involves processing captured intensity images to identify key characteristics of the light source, such as its area, orientation, center of mass, minor axis length and major axis length. Given the distorted shape of the light source, elliptical-shaped detector bands that match the source's shape are incorporated. Detection bands are then defined based on the extracted characteristics of the light source. These adaptively configured detector bands, centered around the light source and based on its characteristics, ensure a consistent source-detector separation (See FIGS. 4A through 4F). The diffused laser speckle contrast (Kₛ) is calculated within the defined detector region using the following equation:

$${K}_{s} = \frac{{σ}_{s}}{〈 I 〉} = \frac{\sqrt{{〈 I 〉}^{2} - 〈 {I}^{2} 〉}}{〈 I 〉}$$

where Kₛ is defined as the ratio of standard deviation (σₛ) over mean intensity ( [symbol] I [symbol] ) in an N×N (e.g., 3×3, 5×5 or 7×7) pixel window. This procedure is iteratively applied to all scanning lines. By aggregating the speckle contrast values of all scanning images and removing the effect of overlapping detector areas through normalization, a 2D matrix of speckle contrast (Kₛ) values can be achieved. The exact relationship between the Kₛ and flow is nonlinear. However, BFI can be approximated as the inverse square of the speckle contrast

$$( BFI ∼ \frac{1}{{K}_{s}^{2}} ) .$$

Convolution functions and kernel matrixes in MATLAB can be leveraged to substantially improve computation efficiency. Presently, the computation time for processing 50 scanning lines is ˜15 seconds, which can be further reduced by leveraging the MATLAB Parallel Computation Toolbox. The promoted computational efficiency coupled with the unique line scanning method allowing to image tissue blood flow in nearly real time.

FC Map Extraction. A series of CBF images over time are utilized to extract FC maps if the imaging speed is sufficiently higher than the low-frequency oscillations of neural activities. Such fast speed can be achieved with the PS-DSCI. Bilinear interpolation and spatial averaging were applied to the time-series stack of CBF maps to balance accuracy with computational efficiency. After applying band-pass filters, a seed-based method was used to extract FC maps from the measured CBF maps. The correlation coefficients between the seed spot and other brain regions are calculated and visualized as a 2D map of FC. The seed-based method heavily relies on prior knowledge for identifying seed regions in the brain. By contrast, the independent component analysis (ICA) approach requires no prior information about spatial or temporal patterns of source signals. The independent components are first identified using filtered time-course CBF data. Then the correlation coefficients between different independent components are calculated and plotted as the FC map.

Surface Geometry Reconstruction. Extracting tissue surface geometry is important for the reconstruction of tissue optical properties and hemodynamics. Furthermore, integration of hemodynamic images with tissue surface geometry enhances the visualization, thus leading to a more nuanced interpretation of the data, and reconstructing geometry corrected images. According to embodiments of the present invention, the same raw intensity images obtained for tissue blood flow reconstruction can be utilized to extract tissue surface geometry. This approach eliminates the need of additional images or supplementary equipment for obtaining tissure surface geometry. With perpendicular illumination, tissue surface geometry with different heights exhibit varied intensity counts in collected raw images. The geometic information is extracted by aggregating the intensity images. Subsequently, the normalized intensity values are utilized to generate a 3D surface map using the “surf” function in MATLAB. Finally, the reconstructed tissue blood flow and surface geometry are integrated to enhance the visualization.

Reconstruction of Tissue Optical Properties and Blood Oxygenation-Multi-wavelength approach. Utilization of two or more distinct wavelengths, variations of [Hb], [HbO₂], and StO₂ are obtained through the modified Beer-Lambert law:

$$\begin{matrix}{Δμ}_{a} ( λ ) = \frac{ln ( \frac{{I}_{λ B}}{{I}_{λ T}} )}{{DPF}_{λ}} \\ Δ [ {HbO}_{2} ] = \frac{{ε}_{H b} ( {λ}_{1} ) Δ {μ}_{a} ( {λ}_{2} ) - {ε}_{H b} ( {λ}_{2} ) Δ {μ}_{a} ( {λ}_{1} )}{{ε}_{H b} ( {λ}_{1} ) {ε}_{H b {O}_{2}} ( {λ}_{2} ) - {ε}_{H b {O}_{2}} ( {λ}_{1} ) {ε}_{H b} ( {λ}_{2} )} \\ Δ [ Hb ] = \frac{{ε}_{H b {O}_{2} ( {λ}_{2} ) Δ {μ}_{a} ( {λ}_{1} ) - {ε}_{H b {O}_{2}} ( {λ}_{1} ) Δ {μ}_{a} ( {λ}_{2} )}}{{ε}_{H b} ( {λ}_{1} ) {ε}_{H b {O}_{2}} ( {λ}_{2} ) - {ε}_{H b {O}_{2}} ( {λ}_{1} ) {ε}_{H b} ( {λ}_{2} )}\end{matrix}$$

Here, Δμₐ(λ) is the relative change of absorption coefficient μₐ at wavelength λ (λ₁=785 nm and λ₂=830 nm). The ε_{Hb}(λ) and ε_{HbO}_{₂}(λ) are the extinction coefficients of Hb and HbO₂. The I_{λB} and I_{λT} are the measured light intensities at the baseline and at time T, respectively. DPF_{λ} is the differential path factor. Combinations of these parameters yield tissue total hemoglobin concentration ([tHb]=[Hb]+[HbO₂]) and tissue blood oxygen saturation StO₂=(HbO₂]/[tHb])×100%.

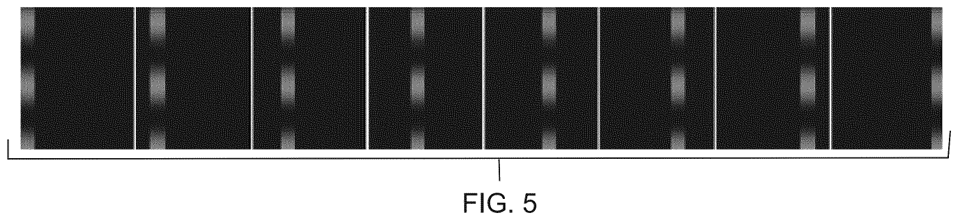

Depth-sensitive SFDI approach. Conventional SFDI uses wide-field structured light illumination to measure tissue absorption and scattering coefficients on tissue surface. Taking advantage of DMD flexibility, line-shape scanning can be created with modulated sinusoidal intensities at different spatial frequencies and distinct phases (0, 120, 240 degrees) (see FIG. 5). Similarly, line-shaped detectors were defined and strategically positioned at a distance from the linear source for deep tissue penetration. Subsequent steps, such as demodulation and calibration mirror the established SFDI technique for extracting μₐ and μ′ₛ. This advancement expands the capabilities of traditional SFDI, enabling a more comprehensive characterization of tissue optical properties.

### Results

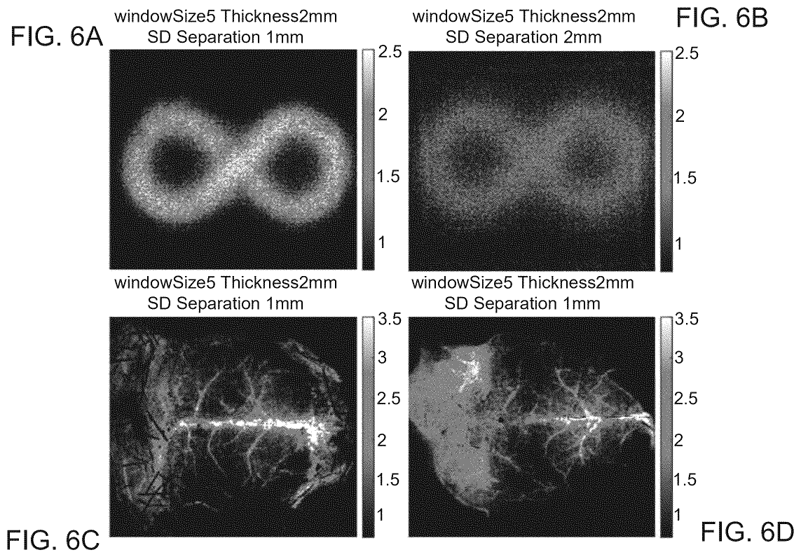

Depth-Sensitive Flow Maps-Phantom Tests. Given the widespread acceptance of using standard tissue-simulating phantoms with known optical properties to validate new methods and technologies, 3D printing techniques were employed to create head-simulating layered phantoms. These phantoms, replicating two layers of head tissues (skull and brain), were utilized to assess the sensitivity of the PS-DSCI in mapping flow distributions at different depths. The solid phantom, incorporating an infinity-shaped channel for the liquid phantom, was produced using a 3D printer (SL1, Prusa). To mimic skulls of different thicknesses, two solid phantoms were printed with top layer thicknesses of 1 and 2 mm, respectively. Comprising titanium dioxide (TiO₂), India ink (India ink, Massachusetts) and clear resin (eSUN Hard-Tough), the solid phantoms were designed to accommodate liquid phantom solutions composed of Intralipid solution (Fresenius Kabi, Sweden), India ink, and water. The concentration of India ink regulated the tissue absorption coefficient (μₐ), while TiO₂ and Intralipid concentrations controlled the reduced scattering coefficient (μ′ₛ). The optical properties of both the solid and liquid phantoms were set at μₐ=0.03 cm⁻¹ and μ′ₛ=9 cm⁻¹ to mimic brain tissue optical properties. The Brownian motion of Intralipid particles within the channels simulated particle flow to mimic the motion of red blood cells in vessels (i.e., blood flow). FIG. 6A depicts the outcomes of the phantom tests. The reconstructed images clearly display the infinity shape channel containing the liquid phantom. The spatial resolution of this method exhibits a strong dependence on measurement depths.

Depth-Sensitive Flow Maps—In Vivo Tests in Mice. To assess the capability of PS-DSCI to penetrate deep through the skull into the brain, tests were conducted on five adult mice with intact skulls. The mice were subjected to 1-2% Isoflurane anesthesia, and the hair on the head and cervical surgical site was removed. Following scalp removal, PS-DSCI measurements were taken using 100 scanning lines, comprising 50 horizontal and 50 vertical lines. FIG. 6B shows CBF maps in two mice, with notable spatial resolution for illuminating cerebral vessels.

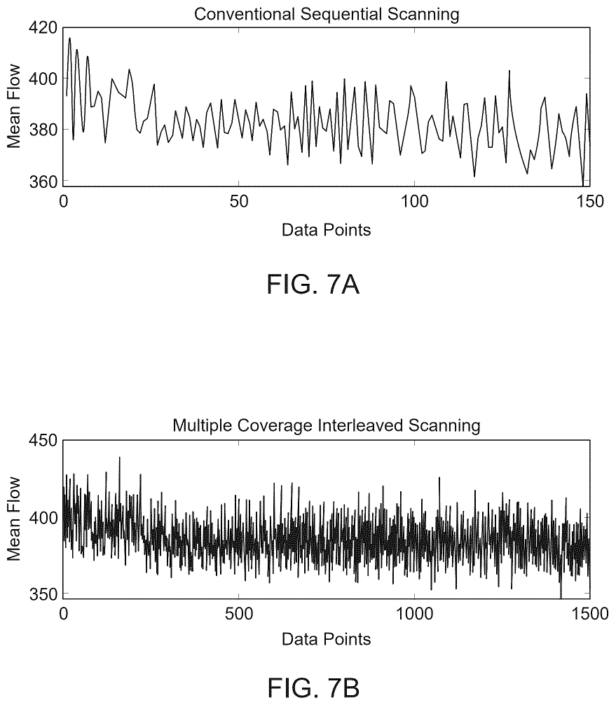

MCIS Results. With the total 100 scanning lines, MCIS methods resulted in a tenfold increase in sampling rate compared to the conventional sequential scanning (see FIGS. 3, 7A and 7B). In general, the sampling rate improvement using MCIS depends on the number of scanning lines and the ROI size. A comparison between the two scanning approaches shows that MCIS can capture flow variations as effectively as conventional sequential scanning while providing many more data points. This high sampling rate reduces scanning artifacts and shows potential for capturing the breathing and heart rates of small animals.

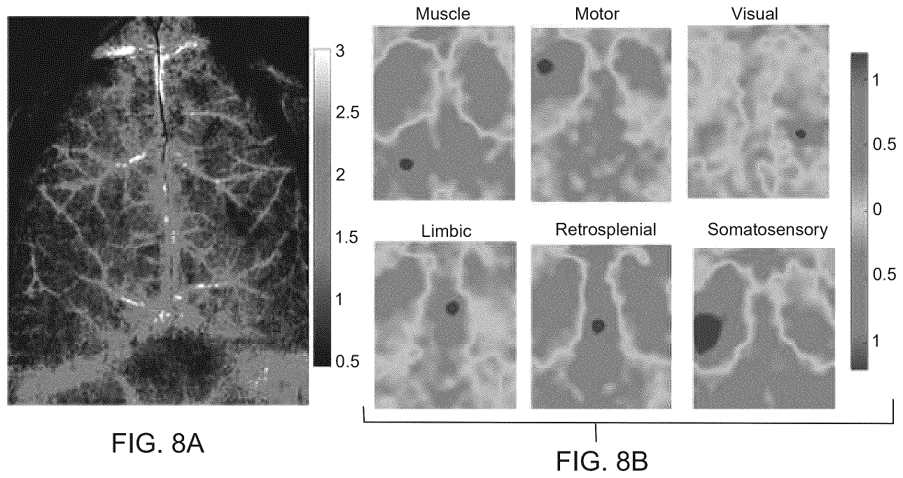

FC Map Reconstruction Results. CBF images in a wild-type adult mouse were continuously recorded by the PS-DSCI at a sampling speed of 0.24 Hz for 10 minutes (FIG. 8A). The seed-based algorithm was employed to extract FC maps (FIG. 8B). The seed locations are typically selected based on a mouse brain atlas, considering various brain regions such as the visual cortex, somatosensory cortex and motor cortex. When the seed is defined in the brain region, correlations between the left and right hemispheres are observed (see FIG. 8B). Conversely, when the seed is defined in the muscle region, no localized correlation is observable between the left and right hemispheres.

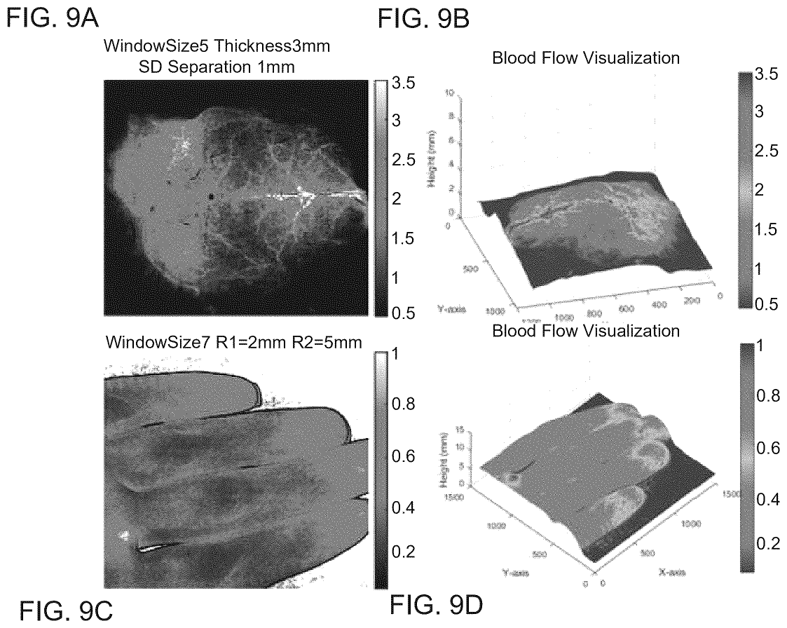

Surface Geometry Reconstruction. The capability of PS-DSCI to reconstruct tissue surface geometry was assessed by imaging mouse heads and human palms. The results demonstrated accurate reconstruction of tissue surface geometries in both cases (see FIGS. 9A through 9D). The simultaneous extraction and visualization of tissue surface geometry and blood flow enabled precise co-registration of structural and functional information. Additionally, surface geometry data is required for the precise reconstruction of blood flow, tissue optical properties and blood oxygenation.

### SUMMARY

Embodiments of the present invention provide a noncontact, portable, depth-sensitive PS-DSCI device capable of imaging tissue blood flow, blood oxygenation and optical properties in near real-time. PS-DSCI utilizes line scanning to generate high spatiotemporal resolution 2D BFI maps. In addition, the MCIS approach can further enhance the temporal resolution of the measurements. The flexibility to define detector bands at multiple source-detector separations enables simultaneous extraction of 2D BFI maps at various tissue depths. Data obtained from the PS-DSCI device allows for the creation of brain FC maps and characterization of tissue surface geometry. The flexibility of the programmable DMD in generating various illumination patterns also allows for integration with SFDI to measure tissue optical properties. The straightforward optical setup facilitates multi-wavelength measurements, supporting the acquisition of tissue oxygenation information. Overall, the innovative PS-DSCI method holds promise for use in animals and humans as a potential alternative to other functional imaging modalities in basic and translational research.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A system for determining deep tissue optical properties, hemodynamics and function comprising:
a laser operable to illuminate coherent near infrared light;
a programable digital micromirror device (DMD) configured to receive light from the laser and operable to generate a flexible scanning beam directed at a region of interest (ROI) of a subject; and
a camera synchronized with the DMD to continuously capture raw intensity images from the ROI.

2. The system of claim 1, wherein the laser is an open space coherent near infrared laser.

3. The system of claim 1, wherein the flexible scanning beam provides line-shaped scanning at the ROI of the subject.

4. The system of claim 1, wherein the laser is a fiber coupled coherent near infrared laser.

5. The system of claim 1, wherein the laser includes multiple lasers used for multispectral imaging.

6. The system of claim 5, wherein an optical switch is used to switch wavelengths.

7. The system of claim 1, further comprising a linear polarizer.

8. The system of claim 1, further comprising a collimating lens receiving light from the laser.

9. The system of claim 2, further comprising an engineered diffuser to create a homogeneous illumination.

10. The system of claim 2, further comprising a mirror for reflecting light from the collimating lens toward a micromirror window of the DMD.

11. The system of claim 1, further comprising a projection lens to receive light from the DMD and deliver it on the ROI.

12. The system of claim 1, further comprising an adjustable zoom lens on the camera.

13. The system of claim 12, further comprising a linear polarizer and a long-pass filter in front of the zoom lens.

14. The system of claim 1, wherein the camera is a scientific complementary metal-oxide semiconductor (sCMOS) camera.

15. The system of claim 1, wherein the camera is an InGaAs (SWIR) (sCMOS) camera.

16. The system of claim 1, wherein the system is portable and movable.

17. The system of claim 1, wherein the DMD generates structured scanning patterns at different phases and/or frequencies.

18. The system of claim 1, wherein the DMD generates different scanning patterns including cross shape scanning, parallel line scanning and multipoint scanning.

19. The system of claim 1, wherein the DMD generates multiple coverage interleaved scanning.

20. A method of determining deep tissue optical properties, hemodynamics and function, comprising:
illuminating coherent light with a laser;
incorporating optics to create widefield homogenous illumination on the DMD;
receiving the homogeneous light on a programable digital micromirror device (DMD);
directing a line shape beam, generated from the DMD;
incorporating optics to magnify the pattern at a region of interest (ROI) of a subject; and
continuously capturing raw intensity images from the ROI with a camera synchronized with the DMD.

21. The method of claim 20, further comprising:
passing the light from the laser through a collimating lens; and
reflecting light from the collimating lens toward a micromirror window of the DMD with a flat mirror.

22. The method of claim 20, further comprising:
adjusting a zoom lens to focus on the ROI; and
disposing a linear polarizer and a long-pass filter in front of the zoom lens.

23. The method of claim 20, further comprising generating, by the DMD, structured scanning patterns at different phases and/or frequencies.

24. The method of claim 20, further comprising:
defining a detection area located at certain distances from the source;
selectively capturing diffused photons originating from certain depths within the subject with the camera to effectively eliminate single-scattering photons emanating from the surface of the tissue; and
generating 2-dimensional maps of tissue blood flow at different depth in real time.

25. The method of claim 20, further comprising:
processing captured intensity images by the camera to identify key characteristics of the scanning source on the ROI;
defining automatically adjusted detection bands based on the identified key characteristics of the scanning source to ensure a consistent source-detector separation.

26. The method of claim 20, further comprising utilizing a stack of reconstructed cerebral blood flow images over time to extract functional connectivity (FC) maps.

27. The method of claim 20, further comprising extracting tissue surface geometry from the raw intensity images obtained by the camera.

28. The method of claim 20, further comprising extracting tissue oxygenation images from multiple wavelength data.

29. The method of claim 20, further comprising extracting tissue optical properties from structured illumination data.

30. An integrated instrument for performing continuous measurements, comprising:
an open-space coherent laser operable to illuminate coherent infrared light;
a programable digital micromirror device (DMD) configured to receive light from the laser and operable to generate a line shape beam directed at a region of interest (ROI) of a subject; and
a scientific complementary metal-oxide semiconductor (sCMOS) camera synchronized with the DMD to continuously capture raw intensity images from the ROI, wherein
the integrated instrument is portable and movable.

31. The integrated instrument of claim 30, further comprising:
a collimating lens receiving light from the laser;
a flat mirror for reflecting light from the collimating lens toward a micromirror window of the DMD;
a zoom lens on the camera; and
a linear polarizer and a long-pass filter in front of the zoom lens.
